(19) United States
(12) Patent Application Publication
(10) Pub. No.: US 2012/0219484 A1
(43) Pub. Date: Aug. 30, 2012

(54) METHOD AND APPARATUS FOR SEQUESTERING CARBON FROM ATMOSPHERIC AIR USING HYDROXIDE COMPOUND

(76) Inventor: Tyler A. Clark, Saint John, KS (US)

(21) Appl. No.: 13/405,442

(22) Filed: Feb. 27, 2012

Related U.S. Application Data
(60) Provisional application No. 61/447,002, filed on Feb. 25, 2011.

(51) Int. Cl. B01D 53/14; B01D 53/18

(52) U.S. Cl. 423/234; 423/432; 422/124

(57) ABSTRACT

The present invention provides a method and apparatus for sequestering carbon from atmospheric air using a hydroxide compound in a two stage process to maximize carbon dioxide capture. The first stage is provided by a coarse filter saturated with a calcium hydroxide solution. The second stage is provided by a reaction chamber having at least one spray nozzle for creating a mist of hydroxide solution within the reaction chamber. Air is drawn through the device by a fan to cause the air to first contact the hydroxide solution on the saturated filter, and then to contact the hydroxide solution in the mist sprayed within the reaction chamber. The hydroxide solution is collected in a reservoir, centrifuged to separate the captured carbon from the solution, and then recirculated back into the saturated filter and through the spray nozzles into the reaction chamber.

### RELATED APPLICATIONS

This application claims priority of U.S. Provisional Application No. 61/447,002 filed on Feb. 25, 2011. The content of this prior application is incorporated herein by reference.

### BACKGROUND OF THE INVENTION

1. Field of the Invention

This invention relates generally to methods and devices for capturing carbon from atmospheric air, and particularly to methods and devices for capturing carbon from atmospheric air using hydroxide compounds.

2. Description of the Related Art

The process of carbon sequestration is useful in current industry in regards to complying with social and economic reform. Our population is ever increasing which leads to a need for further production of resources. The production of these resources causes a monumental rise in the amount of carbon dioxide gas present in the atmosphere.

Carbon dioxide is a green house gas that is essential to our livelihood as a race; however, the amount of carbon dioxide needed to sustain life in the atmosphere has been far surpassed over the last fifty years at the global volume. Whether or not we believe in the idea of climate change we can see that there has certainly been a rise in atmospheric carbon dioxide concentration that correlates to a rise in temperature and disease. Based on these observations lawmakers have begun to implement legislation to combat the overproduction of carbon dioxide.

Cap and trade legislation governs the amount of carbon dioxide that companies in the borders of the United States can produce. Companies are evaluated on production and environmental sanctions to determine the amount in tons of carbon dioxide that they can produce. If a company produces more than the allotted amount they are taxed. If a company does not produce the sanctioned amount then they earn a credit. Companies and individuals can also earn credits by implementing technology to reduce their carbon footprint.

Over the past fifty years atmospheric carbon dioxide concentrations have undergone a monumental rise due to an increasing population and production level. This rise has been observed to cause a rise in temperature and an altered global climate state (Keith, Climate Strategy, 2005).

When looking at current technologies associated with carbon capture units in the industrial manufacturing processes, inefficient heating units are the primary option. Within the applications currently utilized the process is often inefficient in reducing the carbon footprint (Minh Ha-Dong, Climate Strategy, 2005). The current research associated with carbon capture tends to lean towards a means of air compression with thermodynamic emphasis (Stolaroff, Hydroxide Spray, 2008). In prior research, hydroxides have proven to be feasible compounds for use in carbon dioxide contactors (Stolaroff, Hydroxide Spray, 2008).

Carbon dioxide exists in ambient air in minute concentrations in comparison to other gaseous compounds (Chang, Chemistry, 2006). The reactions between hydroxide compounds and this minute concentration of carbon dioxide gas takes place at ambient conditions (Stolaroff, Hydroxide Spray, 2008).

The following studies are related to the subject matter of the Applicant's invention and are hereby incorporated by reference:
1. Chang, R. (2006). Mass Relationships in Chemical Mass. Chemistry (8 ed., pp. 127-175). London: Mcgraw Hill.
2. Dong, M. H. (2005). Climate Strategy. Austin: University Of Texas.
3. Keith, D. (2005). Climate Strategy with CO2 Capture from the Air. Calgary: University Of Calgary.
4. Keith, D. (2009). Why Capture CO2 from Air?. Calgary: University Of Calgary.
5. Stolaroff, J. (2008). Snatching Carbon Dioxide from the Atmosphere. Pittsburgh: Carnegie Mellon.
6. Stolaroff, J. (2008). Carbon Dioxide Capture from Air using Sodium Hydroxide Spray. Pittsburgh: Carnegie Mellon.

There is a need for improved methods and systems for capturing carbon dioxide from atmospheric air.

### SUMMARY OF THE INVENTION

An object of the present invention is to provide a method and apparatus that can be used to efficiently sequester carbon from atmospheric air to reduce atmospheric carbon dioxide concentrations.

A further object of the present invention is to provide a method and apparatus that does not require massive energy inputs or expensive catalysts to accomplish carbon sequestration from ambient air.

A still further object of the present invention is to provide a method and apparatus that is cost effective, that captures more carbon than it releases, and that is simple to manufacture and efficient in operation, and that is capable of a long sustainable operating life.

The present invention provides a valuable tool for individuals and companies to utilize to reduce carbon dioxide in atmospheric air. A company can earn credits for implementing the present invention at a location where carbon dioxide is being produced. The process uses sequestration to capture excess carbon dioxide and convert it to a useable and storable carbonate compound. The process will be particularly useful in areas where coal fired power plants are used. The carbon dioxide can be taken from the coal production and utilization process and converted into a calcium-based product, such as a supplement for livestock. The process can also be used to produce bicarbonates that can be utilized in soil cultivation to produce greater and healthier yields of corn and soybeans. Farmers who use this technology would gain the option to sell carbon credits to companies.

The apparatus is powered by a solar voltaic cell, the cleanest form of solar energy. The solar panels maintain a lithium ion battery pack that powers the entire unit. The use of solar energy assures that the device will not be producing carbon dioxide, only capturing it.

The present invention offers many practical benefits to companies and individuals. With taxation on carbon dioxide taking place we cannot afford to lose business in the United States. The present invention helps fulfill our social responsibility of environmental stewardship.

To accomplish these and other objects, the present invention provides a method and apparatus for sequestering carbon from atmospheric air using a hydroxide compound in a two stage process to maximize carbon dioxide capture. The first stage is provided by a coarse filter saturated with a calcium hydroxide solution. The second stage is provided by a reaction chamber having at least one spray nozzle for creating a mist of hydroxide solution within the reaction chamber. Air is drawn through the device by a fan to cause the air to first contact the hydroxide solution on the saturated filter, and then to contact the hydroxide solution in the mist sprayed within the reaction chamber. The hydroxide solution is collected in a reservoir, centrifuged to separate the captured carbon from the solution, and then recirculated back into the saturated filter and through the spray nozzles into the reaction chamber.

According to one aspect of the present invention, a method of sequestering carbon from atmospheric air is provided, comprising: passing air through a filter saturated with a hydroxide solution to provide a first stage of carbon capture from the air; and passing the air through a reaction chamber containing a mist of hydroxide solution to provide a second stage of carbon capture from the air.

According to another aspect of the present invention, an apparatus for sequestering carbon from atmospheric air is provided, comprising: a filter saturated with a hydroxide solution; a reaction chamber having at least one nozzle for creating a mist of hydroxide solution within said reaction chamber; a fan for drawing air through the saturated filter and the reaction chamber to cause the air to contact the hydroxide solution and carbon in the air to be captured by the hydroxide solution; a means for collecting and recirculating the hydroxide solution back into the saturated filter and the reaction chamber; and a means for separating the captured carbon from the collected hydroxide solution.

Numerous other objects of the present invention will be apparent to those skilled in this art from the following description wherein there is shown and described an example embodiment of the present invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the present invention is made with reference to the accompanying drawings. In the drawings:

FIG. 1 is a diagram of an apparatus for capturing carbon from atmospheric air according to a first embodiment of the present invention.

FIG. 2 is a graph showing the results of testing performed with the apparatus shown in FIG. 1 using a sodium hydroxide solution.

FIG. 3 is a graph showing the results of testing performed with the apparatus shown in FIG. 1 using a calcium hydroxide solution.

FIG. 4 is a diagram of another apparatus for capturing carbon from atmospheric air according to a second embodiment of the present invention.

### DETAILED DESCRIPTION OF THE INVENTION

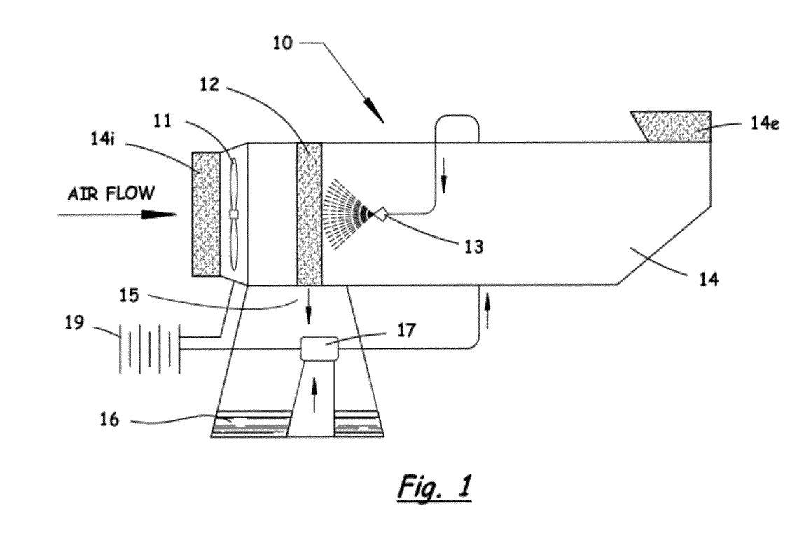

A method and apparatus for capturing carbon from atmospheric air according to the present invention will now be described in detail with reference to FIGS. 1 to 4 of the accompanying drawings.

Carbon dioxide emissions have the ability to be controlled using different methods of air capture. Hydroxide air capture is one application that may be utilized in industrial processes. Two different hydroxide compounds, sodium hydroxide and calcium hydroxide, were evaluated for use in the present invention. The reaction between aqueous sodium hydroxide and gaseous carbon dioxide to produce solid sodium bicarbonate is shown by the following chemical equation:

NaOH(aq)+CO₂(g)→NaHCO₃(s) Equation 1:

The reaction between aqueous calcium hydroxide and gaseous carbon dioxide to produce calcium carbonate and water is shown by the following chemical equation:

Ca(OH)₂(aq)+CO₂(g)→CaCO₃(s)+H₂O Equation 2:

In comparing the two chemicals under controlled conditions based on a variety of factors, including total amount of carbon dioxide captured, the most effective hydroxide compound for carbon capture in the present invention was determined. Air capture using hydroxides to trap carbon may prove useful in lowering global carbon emissions.

The testing used to evaluate the hydroxide compounds used the apparatus 10 depicted in FIG. 1. The apparatus 10 includes an electric fan 11 used to draw ambient air through a highly coarse, porous polyester filter 12 saturated with a hydroxide compound. The porous filter 12 was saturated by spraying the hydroxide solution from a fan-shaped distribution nozzle 13 that delivered the solution directly to the surface of the filter 12. The carbon dioxide gas contained in the air flowing through the apparatus 10 contacts the hydroxide compound contained on the filter 12 and reacts according to the chemical equations described above.

To evaluate the different hydroxide compounds, the filter 12 was saturated with a predetermined amount (e.g., five milliliters) of a thirty percent hydroxide solution. The chamber 14 used to isolate the reaction was formed by a polymer vinyl chloride tubing. Within the chamber 14, the filter 12 was vertically positioned over a drainage point 15. Solution was continually pumped to the nozzle 13 from a reservoir 16 positioned below the drainage point 15 to ensure equal saturation of the entire surface area of the filter 12. An electric pump 17 was used to pump the solution to the nozzle 13 via a rubber tubing 18.

The chamber 14 was fully enclosed to ensure no hydroxide was lost during the circulation process. An inlet air filter 14i and exit air filter 14e cover the inlet and exit openings of the chamber 14, respectively. The fan 11 was used to circulate air containing carbon dioxide through the inlet air filter 14i into the chamber 14 to react with the hydroxide on the filter 12. The reaction produced a precipitate of carbonate on the filter 12 while excess hydroxide was re-circulated. The fan 11 and pump 17 can be powered by a battery 19 or other suitable power source.

The hydroxide solutions for both sodium hydroxide and calcium hydroxide were prepared in the aqueous state at thirty percent concentrations. Tests were conducted using each compound thirty times. Calcium carbonate and sodium bicarbonate were collected from each filter 12 and measured using a Scientech ZSA210 gram balance. Between each test deionized water was used to rinse the entire device to a neutral value using phenolphthalein indicator. Once all tests were performed, stoichiometry equations were used along with molecular mass values to determine the total amount of carbon dioxide captured during each test.

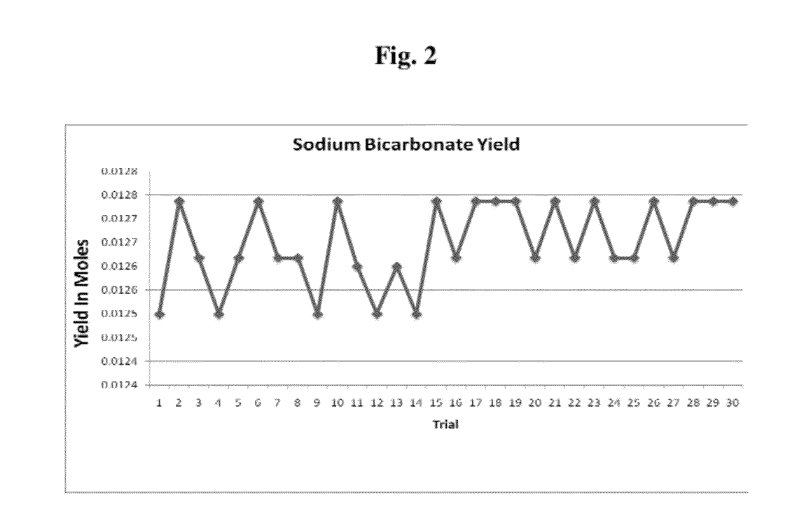

Sodium hydroxide reacted with carbon dioxide in the ambient volume of air according to Equation 1 to produce sodium bicarbonate. The reaction took thirty-eight hours to maximize the amount of carbon dioxide captured. The average mass of carbon dioxide collected using sodium hydroxide as a capturing compound was 1.26 grams (FIG. 2). The use of sodium hydroxide in testing also confirmed the caustic nature of the compound. Solubility of sodium bicarbonate also proved essential to the time component. Being a soluble salt, sodium bicarbonate was washed back into solution during testing increasing the amount of time needed to carry out one reaction.

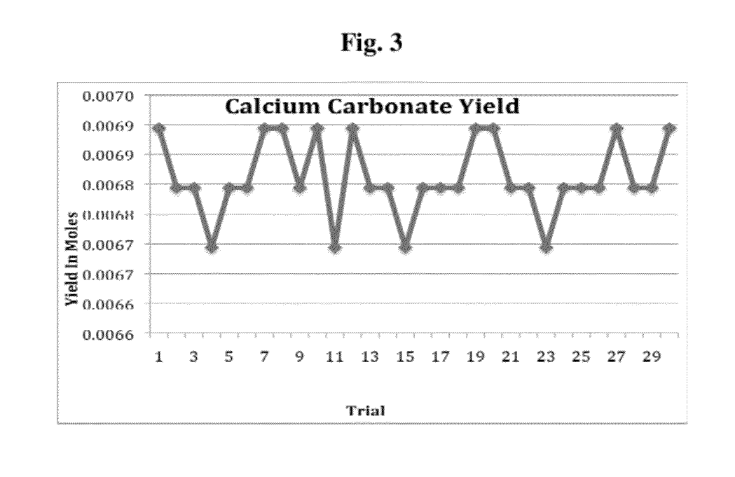

Calcium hydroxide reacted with carbon dioxide in the ambient volume of air according to Equation 2 to produce calcium carbonate. The reaction took only twelve hours (in contrast to the 38 hours taken by sodium hydroxide) to maximize the amount of carbon dioxide captured. The average mass of carbon dioxide collected using calcium hydroxide as a capturing compound was 0.681 grams (FIG. 3). Calcium hydroxide did not exhibit a caustic nature as high as that of sodium hydroxide. This was confirmed based on the principle of the element calcium being an alkaline earth metal, whereas sodium is an alkali metal. The insoluble nature of calcium carbonate made the factor of time far less of a problem than in the testing of sodium hydroxide. The collection of calcium carbonate was also far greater in that it was much less dense than the sodium bicarbonate.

When looking at the comparison between the two hydroxides for use in a geoengineering application multiple factors were considered. While sodium hydroxide captured a greater amount of carbon dioxide, the time factor was three times greater than that of calcium hydroxide in completing an effective reaction. The safety precautions associated with calcium hydroxide are also far less than those for sodium hydroxide. Both chemicals are highly caustic, but once again periodic placement can be seen in that sodium is far more reactive due to its charge. When looking at the feasibility of both solutions for carbon capture, both appear to be equally feasible from an economic standpoint. Finally, ease of collection favors calcium hydroxide. Based upon the results of this study calcium hydroxide appears to be the most effective and feasible hydroxide compound to utilize for carbon dioxide capture.

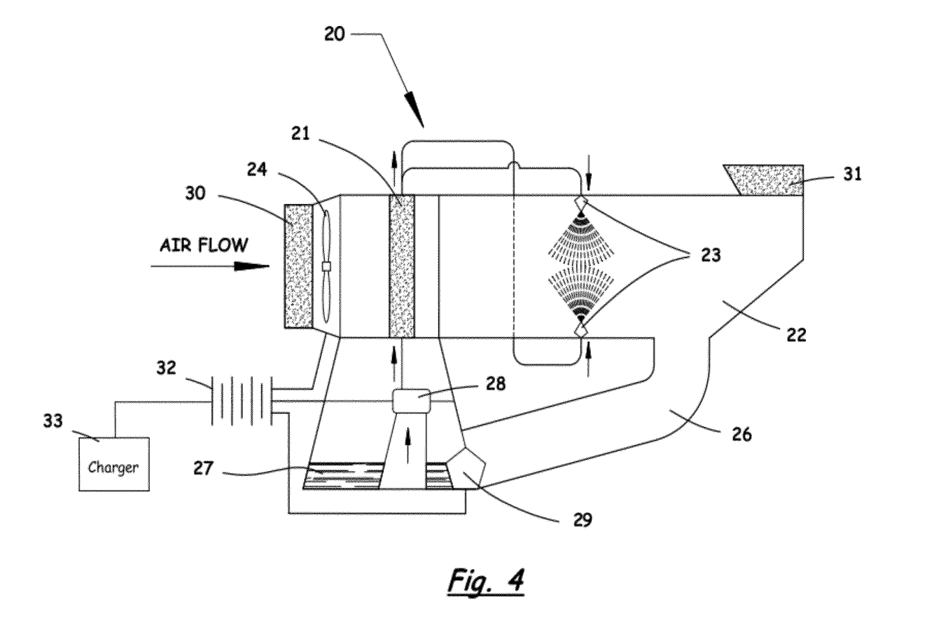

FIG. 4 illustrates an apparatus 20 for capturing carbon from atmospheric air according to another embodiment of the present invention. The apparatus 20 uses a two stage process to maximize carbon dioxide capture. The first stage is provided by a coarse filter 21 saturated with a hydroxide solution. The second stage is provided by a reaction chamber 22 having at least one nozzle 23, and preferably a plurality of nozzles 23, for creating a fine mist of hydroxide solution within the reaction chamber 22. The illustrated embodiment has two nozzles 23 each providing a cone-shaped spray pattern to create a fine mist of hydroxide solution within the reaction chamber 22. The hydroxide solution is preferably a calcium hydroxide solution.

A fan 24 is provided for drawing air through the saturated filter 21 and the reaction chamber 22 to cause the air to contact the hydroxide solution, and the carbon in the air to be captured by the hydroxide solution. Thus, the saturated filter 21 functions as the preliminary contactor for contacting the air moving through the system in the first stage of the process. The first stage starts the separation of carbon compounds and lowers the total concentration of carbon dioxide from the volume of air passing through the system. The first stage greatly increases the amount of carbon dioxide removed from ambient air by the total system. The air passing through the saturated filter 21 is divided so that at least some of the molecules of carbon within the air are separated before the air enters the reaction chamber 22.

The air that continues beyond the saturated filter 21 enters the reaction chamber 22, which is positioned horizontally in the air flow downstream from the saturated filter 21. The air is contacted again by the fine mist of hydroxide solution sprayed within the reaction chamber 22. The reaction chamber 22 thus provides the second stage of carbon capture to collect more carbon from the partially treated air before the air leaves the apparatus 20 through the exit air filter 25. The two stage process of the present invention provides a greater capture or absorption of carbon from the ambient air passing through the apparatus 20, and therefore maximizes the potential yield and effectiveness of the system.

A means is provided for collecting and recirculating the hydroxide solution back into the saturated filter 21 and the reaction chamber 22. The means for collecting includes a sloped floor and recirculation pipe 26 or other suitable structure that directs the excess solution by gravity flow from the reaction chamber 22 and the lower end of the saturated filter 21 into a hydroxide solution reservoir 27. A pump 28 is used to recirculate the hydroxide solution back into the saturated filter 21 and the spray nozzles 23 in the reaction chamber 22.

When a calcium hydroxide solution reacts with carbon dioxide in atmospheric air, a highly insoluble calcium carbonate compound is formed. A simple centrifuge 29 can therefore be used to separate the captured carbon in its calcium carbonate form from the collected hydroxide solution. The centrifuge 29 functions as a high speed stirring mechanism that provides adequate separation of the captured carbon in carbonate form from the solution. For example, centrifuge technologies disclosed in U.S. Pat. Nos. 4,199,459, 5,792,039 and/or 6,110,096, all of which are incorporated herein by reference, can be used to separate calcium carbonates or other particulates from the solution before the hydroxide solution is recirculated back into the saturated filter 21 and the reaction chamber 22.

The hydroxide solution used in the present invention has a concentration of calcium hydroxide of approximately 7 to 30 percent by volume, and preferably about 30 percent.

An inlet air filter 30 is provided at the inlet of the apparatus 20 for preventing insects and dust from entering the apparatus. An exit air filter 31 is provided at the outlet of the apparatus 20 for preventing insects and animals from entering the apparatus against the air flow, and for preventing hydroxide compounds from exiting the apparatus. The saturated filter 21 and the reaction chamber 22 are located in an air flow path between the inlet air filter 30 and the exit air filter 31.

The pump 28, centrifuge 29 and fan 24 are preferably powered by a rechargeable battery 32. A wind- or solar-powered battery charger 33 can be used to allow the system to be completely energy independent, so that it does not need to rely on outside energy sources that release carbon dioxide.

The apparatus 20 of the present invention is an improvement over prior art systems because, among other things, it does not require massive energy input or expensive catalysts to separate carbon compounds from the air, which would tend to negate the benefits of carbon reduction. Instead, the present invention relies on chemical compounds, gravity, the structures described above, renewable energy (e.g., solar), and an efficient two stage process to maximize the absorption of excess carbon dioxide from ambient air.

The apparatus 20 of the present invention can be constructed as a small portable device to make it feasible for use by individuals and small companies. For example, in an urban area a small portable device can be placed on a rooftop to cut carbon emissions from vehicles and production processes. Individuals can place such devices in their yard or on their rooftop to cut their own emissions, thereby reducing their carbon footprint.

With the purpose of carbon capture being to reduce the level of carbon dioxide emissions released into the atmosphere, a permanent source of storage and/or usage for the product calcium carbonate may be explored. Calcium carbonate can be used as a hydrogen regulator in soils, as well as in vitamin supplements for livestock. Another proposed solution would be to pump the carbonate into depleted fossil fuel reservoirs for permanent storage.

The present invention uses a preliminary filter carbon capture system along with a reaction chamber utilizing a fine mist of aqueous calcium hydroxide to maximize carbon capture at an industrial level. These devices could also be powered by alternative energy sources, including solar and wind applications.

Research could be continued to improve the effectiveness of carbon capture chemicals for implementation. Other hydroxides, including but not limited to potassium hydroxide and lithium hydroxide, could be explored. To make these new chemicals effective a regeneration process for recovery of metals would also need to be explored.

Carbon capture offers one outlet to the overall dilution of atmospheric carbon dioxide concentrations. However, standing alone it is not a valid solution. Social efforts including carbon dioxide production mandates along with individual production decrease are quintessential to the overall reduction of carbon dioxide at the global volume.

While the invention has been specifically described in connection with specific embodiments thereof, it is to be understood that this is by way of illustration and not of limitation, and the scope of the appended claims should be construed as broadly as the prior art will permit.

What is claimed is:

1. A method of sequestering carbon from atmospheric air, comprising:
passing air through a filter saturated with a hydroxide solution to provide a first stage of carbon capture from the air; and
passing the air through a reaction chamber containing a mist of hydroxide solution to provide a second stage of carbon capture from the air.

2. The method according to claim 1, wherein said hydroxide solution comprises calcium hydroxide.

3. The method according to claim 2, wherein said hydroxide solution comprises a concentration of calcium hydroxide of 7 to 30 percent by volume.

4. The method according to claim 3, wherein said hydroxide solution comprises a calcium hydroxide concentration of approximately 30 percent by volume.

5. The method according to claim 1, further comprising collecting the hydroxide solution from said saturated filter and said reaction chamber, and separating the captured carbon from said collected hydroxide solution.

6. The method according to claim 5, further comprising recirculating the collected hydroxide solution back to the saturated filter and/or the reaction chamber after separating the captured carbon from the collected hydroxide solution.

7. The method according to claim 1, further comprising collecting the hydroxide solution after the hydroxide solution contacts the air, and using a centrifuge to separate captured carbon from the collected hydroxide solution.

8. The method according to claim 7, wherein said centrifuge comprises a high speed stirring mechanism that provides separation of the captured carbon in solution.

9. The method according to claim 1, further comprising passing the air through an inlet air filter to prevent insects and dust from entering the system, and through an exit air filter to prevent hydroxide compounds from entering the atmosphere, wherein said first and second stages of carbon capture are performed on the air moving between the inlet and exit air filters.

10. The method according to claim 9, further comprising using a powered fan to draw air through the system.

11. An apparatus for sequestering carbon from atmospheric air, comprising:
a filter saturated with a hydroxide solution for providing a first stage of carbon capture;
a reaction chamber having at least one nozzle for creating a mist of hydroxide solution within said reaction chamber for providing a second stage of carbon capture;
a fan for drawing air through the saturated filter and the reaction chamber to cause the air to contact the hydroxide solutions in said saturated filter and said reaction chamber, and carbon in the air to thereby be captured by the hydroxide solutions in said first and second stages;
a means for collecting and recirculating the hydroxide solution back into the saturated filter and the reaction chamber; and
a means for separating the captured carbon from the collected hydroxide solution.

12. The apparatus according to claim 11, wherein said hydroxide solution comprises calcium hydroxide.

13. The apparatus according to claim 12, wherein said hydroxide solution comprises a concentration of calcium hydroxide of 7 to 30 percent by volume.

14. The apparatus according to claim 13, wherein said hydroxide solution comprises a calcium hydroxide concentration of approximately 30 percent by volume.

15. The apparatus according to claim 11, wherein said means for separating the captured carbon from the collected hydroxide solution comprises a centrifuge comprising a high speed stifling mechanism that provides separation of the captured carbon in solution.

16. The apparatus according to claim 11, further comprising an inlet air filter for preventing insects and dust from entering the apparatus, and an exit air filter for preventing hydroxide compounds from exiting the apparatus, wherein said saturated filter and said reaction chamber are located in an air flow path between said inlet and exit air filters.

17. The apparatus according to claim 11, wherein said at least one nozzle comprises two nozzles each providing a cone-shaped spray pattern to create a mist of hydroxide solution within the reaction chamber.

18. The apparatus according to claim 11, wherein said means for recirculating the hydroxide solution comprises a motorized pump, said means for separating the captured carbon from the collected hydroxide solution comprises a centrifuge, and said pump, centrifuge and fan are powered by a rechargeable battery.
